(19) United States
(12) Patent Application Publication
(10) Pub. No.: US 2021/0041867 A1
(43) Pub. Date: Feb. 11, 2021

(54) DEVICE AND METHOD FOR PROVIDING AN ENHANCED GRAPHICAL REPRESENTATION BASED ON PROCESSED DATA

(71) Applicant: Reveal Technology, Inc., San Francisco, CA (US)

(72) Inventors: Robert Parker Clark, Palo Alto, CA (US); W. Garret Smith, WOODSIDE, CA (US); John D. Laxson, SAN FRANCISCO, CA (US); Andrew van Dyke Dixon, ATHERTON, CA (US)

(73) Assignee: Reveal Technology, Inc., SAN FRANCISCO, CA (US)

(21) Appl. No.: 16/807,166

(22) Filed: Mar. 3, 2020

Related U.S. Application Data
(60) Provisional application No. 62/922,393, filed on Aug. 7, 2019.
(60) Provisional application No. 62/922,413, filed on Aug. 8, 2019.

(51) Int. Cl. G05D 1/00; G06K 9/32; B64C 39/02; H04W 4/029

(52) U.S. Cl. CPC G05D 1/0044; G05D 1/0016; G05D 1/0038; B64C 2201/12; B64C 39/024; H04W 4/029; G06K 9/3233

(57) ABSTRACT

A first mobile device or other portable computer receives an originally unified or previously combined data set and algorithmically processing at least two portions of the data set by different algorithmic processes and displaying the resultant information in an enhanced imaging on a video screen of the first device. The original data set can be preprocessed by a second device, and the resultant information generated in this data preprocessing by the second computational device is provided to the first device for additional processing and display to a user. The first device applies an alternate and distinctively different second algorithmic process to the resultant information and/or the original data set to generate a second information, whereupon the first device visually presents (a.) elements of the second information; (b.) elements of the resultant information as generated by the second device; and/or (c.) some or all of the original data set.

### CO-PENDING PATENT APPLICATIONS

This Nonprovisional Patent Application is a Continuation-in-Part Patent Application to Provisional Patent Application Ser. No. 62/922,393 as filed on Aug. 7, 2019 by Inventors Robert Parker Clark, John D. Laxson, Andrew van Dyke Dixon and William Garrett Smith. Provisional Patent Application Ser. No. 62/922,393 is hereby incorporated into its entirety and for all purposes into the present disclosure.

In addition, this Nonprovisional Patent Application is a Continuation-in-Part Patent Application to Provisional Patent Application Ser. No. 62/922,413 as filed on Aug. 8, 2019 by Inventors Robert Parker Clark, John D. Laxson, Andrew van Dyke Dixon and William Garrett Smith. Provisional Patent Application Ser. No. 62/922,413 is hereby incorporated into its entirety and for all purposes into the present disclosure.

### FIELD OF THE INVENTION

The method of the present invention relates to devices and methods for producing an enhanced graphical representation based on received data by application of algorithmic processing.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Technologies such as satellite imaging, remote-controlled camera drones, and the software to piece together all the photo data they gather into usable maps have made large-scale, detailed maps of every corner of the world an everyday phenomenon. Though sufficient for most purposes, these maps are generally months or years out of date, but then, if one should need a similar-quality map of a nearby area that is up-to-the minute current, the same technology can also be utilized on a smaller scale to generate it for oneself, for instance by flying a remote-controlled drone equipped with a camera over the landscape, compiling the video the camera takes into a panoramic image, and thus generating current map of the area. This process is already known in the art, especially as a means for gathering information to guide military operations.

Further, if one has the computing resources to do so, one could even enhance that raw captured image, or algorithmically analyze the video data to infer and display more information—also very useful technology to deploy in the surveying of a battlefield. However, having the computing resources to provide this high-level analysis and enhancement is a challenge for a computing device small enough to be carried around by a soldier on the ground.

It's already known in the art to get around the computing power limitation of a small local device by having a big centralized server do all the processing and just send the smaller device the finished product; but naturally, this limits the local device user's autonomy. In the case of a battlefield, the soldier on the ground can only passively look at what is sent, without being able to control the view based on his or her own situational knowledge and judgement. Further, it would be only limitedly feasible for a user of such a system to operate without that sophisticated, external base of server support, discouraging any smaller-scale application, such as a small team packing along a drone and tablet for a mission far from their home base and its server stack, or even a hobbyist with no server stack using a drone with a camera for an amateur project.

There is therefore a long-felt need to improve the effectiveness of a computational device to provide an improved level of visualized information to one or more portions of an originally unified or collectively formed volume or collection of digitized information.

### SUMMARY AND OBJECTS OF THE INVENTION

Towards this object and other objects that are made obvious to one of ordinary skill in the art in light of the present disclosure, the method of the present invention provides a first computational device, such as but not limited to, a mobile device or other portable computer, receiving an originally unified or previously combined data set and algorithmically processing at least two portions of the data set by distinctively different algorithmic processes and displaying the resultant information in an enhanced imaging on a video screen of the computational device.

In an optional and alternate aspect of the method of the present invention, some or all of the data set (“the original data set”) is preprocessed by a second computational device that is remote from the first computational device, and the resultant information generated in this data preprocessing by the second computational device is provided to the first computational device for additional processing and display to a user. In an additional optional method of the present invention, the first computational device applies an alternate and distinctively different second algorithmic process to a portion of the resultant information and/or the original data set to generate a second information, whereupon the first computational device visually presents (a.) some or all of the second information; (b.) some or all of the resultant information as generated by the second computational device; and/or (c.) some or all of the original data set.

It is understood that, within this context, terms referring to stationary visual media such as ‘image’ or ‘picture’ may be used interchangeably with terms that signify visual media in motion, such as ‘video’. Naturally, all examples shown by the Figures herein are stationary; one is encouraged to imagine them as moving images when the text indicates video, and also consider still images and moving images interchangeable in this context. The invention under discussion might be applied just as well to either still images or moving images.

Further, this invention might be applied to any sort of data that could be represented visually. Battlefield maps generated from videos and further enhanced by analysis algorithms is one obvious application, but others aren't difficult to find or imagine. A surveyor or archeologist might apply a very similar embodiment, with the algorithms looking for patterns that suggest buried bones or buildings instead of tanks. Even applications containing no photographic or video data could be imagined; audio data, text data, or just raw numbers are not a bitmap, vector, or video, but any of these can be displayed on a screen, and someone working with these might easily benefit from a pattern-finding and visual analysis tool that creates visual representations and enhanced maps.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

The invention will now be further and more particularly described, by way of example only, and with reference to the accompanying drawings in which:

FIG. 1A is a diagram presenting a system of devices implementing a preferred embodiment of the invented method;

FIG. 1B is a diagram presenting a system of devices implementing an alternative preferred embodiment of the invented method;

FIG. 2 is a representation of an image 1 and image 2 being overlaid together as described herein;

FIG. 3 is a pair of very simple stick-figure diagrams presenting the invented method as applied to the second of two video images of the same example fictional landscape;

FIG. 4 is a block diagram of the computing device of FIGS. 1A and 1B;

FIG. 5 is a flowchart presenting a broad overview of the invented method as enacted on a mobile device receiving video data and selectively enhancing a screen view;

FIG. 6 is a flow chart presenting a simplified example model of a single step of FIG. 5, showing a process for parsing settings input that directs selection of view options;

FIGS. 7A, 7B, 7C, 7D, and 7E are flowcharts presenting the image generation process as done by both a remote processor and a mobile device, as in the system of FIG. 1B;

FIG. 8 is an alternative method to the method described in FIG. 5 accomplishing the same task;

FIG. 9 is a process chart describing and presenting formulation of a possible object structure of an object-oriented software embodiment of the invented method of FIG. 8;

FIG. 10 is a flow chart presenting additional, optional sub-steps for the flow chart of FIG. 8;

FIG. 11 is a diagram presenting a few possible embodiments of user interface controls for providing input for operating the device of FIG. 1 in accordance with the invented method; and

FIG. 12 is a block diagram of the computing components of the drone of FIG. 1.

### DETAILED DESCRIPTION OF DRAWINGS

In the following detailed description of the invention, numerous details, examples, and embodiments of the invention are described. However, it will be clear and apparent to one skilled in the art that the invention is not limited to the embodiments set forth and that the invention can be adapted for any of several applications.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limit's ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

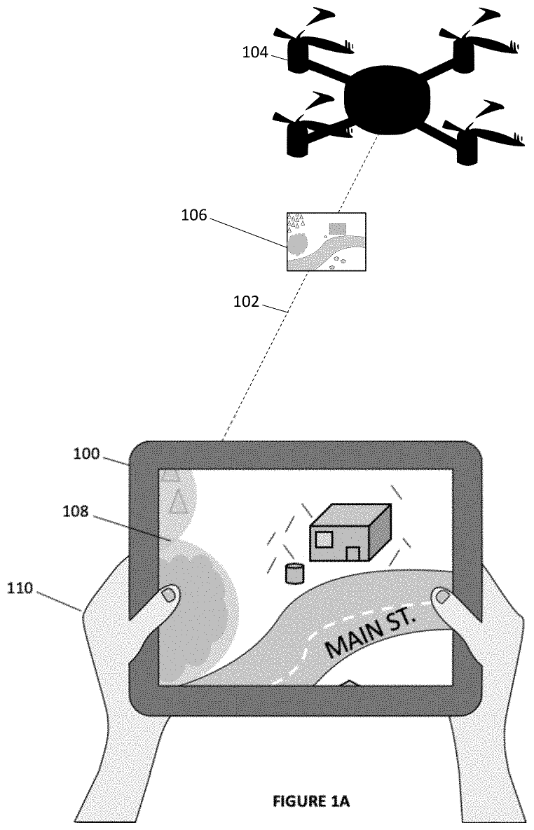

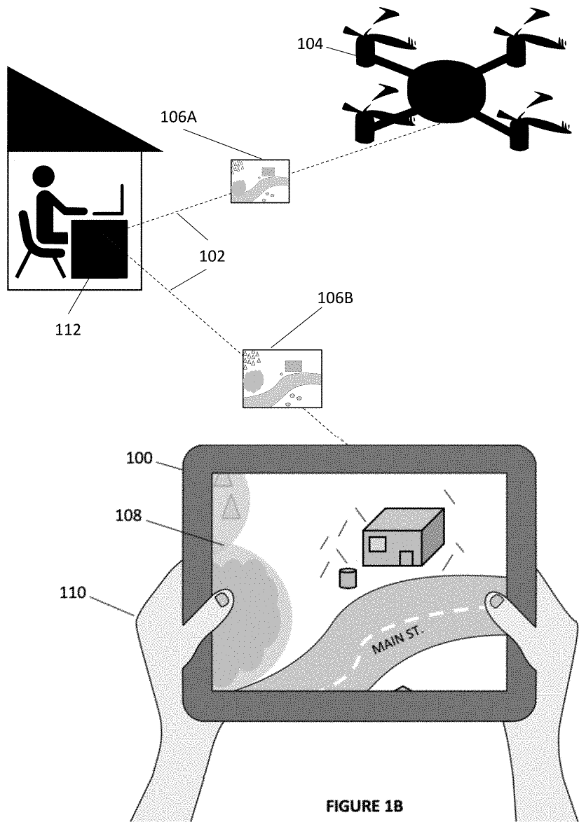

Referring now generally to the Figures and particularly to FIG. 1A, FIG. 1A is a diagram presenting a system of devices implementing a preferred embodiment of the invented method. In the diagram, a local device 100 such as a tablet computer is communicatively coupled via a wireless remote connection 102, to a remote visual data source such as a drone 104 equipped with at least one camera, and data 106 such as video data is sent from the visual data source to the device 100, for the device 100 to process and display as an enhanced screen view 108 for a user 110.

In a preferred application and embodiment of the invented method, the visual data source consists of one or more remote-controlled drones 104 flying over a landscape such as a battlefield and transmitting one or more video data 106 gathered with cameras attached to the drones, such as images or video of landscape features or terrain, to the device 100, to inform the user 110 such as a soldier about the surrounding environment and selectively enhance video data 106 obtained from a video data source such as the drone 104 to produce a more informative screen view 108 for the user 110.

In an alternative embodiment for a similar situation, the user 110 doesn't have to take the time or focus to do the selection themselves (as a soldier in a combat situation, this person might understandably have other things to pay attention to), and he or she is provided with an image pre-curated. This could be accomplished algorithmically, wherein the device 100 could be preprogrammed with preferred settings or even preset general criteria by which to interpret any new image. As one possible example of a useful default setting, the device might be preset to detect and enhance objects the user might generally be interested in, such as buildings or roads. In a simplified embodiment, the device might even provide no means for input ‘on the spot’, but include useful preset or pre-loadable algorithms for interpreting and processing any data received.

Referring now generally to the Figures and particularly to FIG. 1B, FIG. 1B presents an alternative embodiment wherein the ‘raw’ data 106A such as video data from the drone(s) 104 flying overhead may be directed to a remote processor 112, such as an automated server or even a technician and their computer (as shown), which might do some or most of the selection and/or processing of the raw video data 106A before passing along a pre-processed video data 106B to one or more devices 100, whereupon the device(s) 100 may enhance or process further (such as to suit individual user settings or directives). This kind of remote support would allow the soldier in a combat situation to just receive information with minimal button-pressing or attention required while still being able to ‘take over’ and adjust their view based on what they need to look at in the moment, and also allow for pairing verbal communication by means such as a radio with a visual aid such as a shared screen view 108.

It should be noted that the expedient of having an external computing resource such as a server 112 do all of the processing, while also useful at least because this method conserves the processing power required from the individual devices in the field in order to supply high-quality visuals, is already known in the art. This is more or less how this kind of data processing is currently done, with the user's device(s) on the ground simply receiving preprocessed images or video from a remote source that does all the ‘heavy lifting’ for them. Among the aims of the present invention is allowing more local autonomy for the users of the local devices, by making it more feasible for a smaller, more portable device cheap enough to be supplied to a large plurality of users to do some or all of the processing work itself and still produce results of sufficient visual quality to be useful.

It should be understood that, for the purposes of the invented method, the visual data source may be any suitable means for providing video data 106 suitable as input for device 100. This could be the drone 104 flying overhead and wirelessly transmitting directly to the device 100, as discussed in FIG. 1A; the data 106 could be sent from a supporting server or resource such as the remote processor 112 discussed in FIG. 1B; or the device 100 might even receive video data 106 by non-wireless means such as a cable link or USB drive, if equipped with the means to do so such as a USB cable port. In the last instance, even the remote connection 102 would be optional, and this might be a useful failsafe if the communication connection were ever damaged or unsafe to use. Use of wireless communications and less analog means for obtaining data 106 would naturally be preferred for convenience and sophistication of functionality, but the invented method requires only that video data 106 be received somehow, and does not specify particular means for transmission.

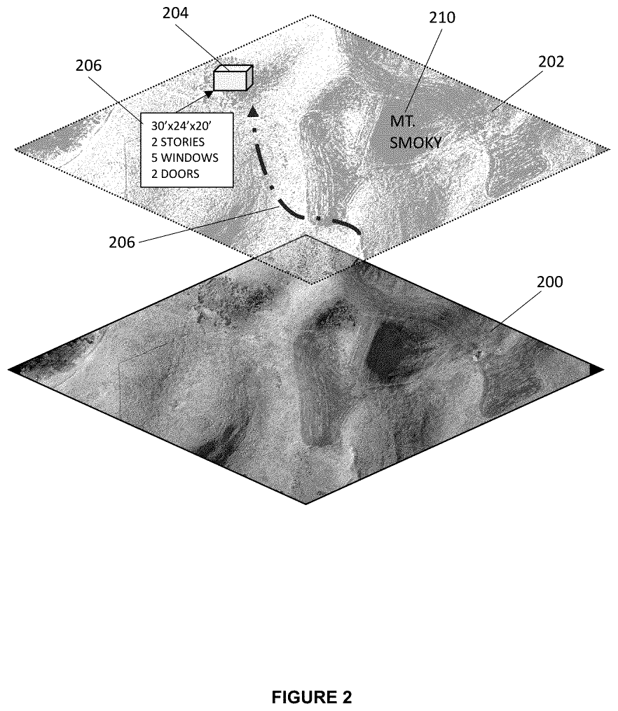

Referring now generally to the Figures and particularly to FIG. 2, FIG. 2 is a diagram presenting a ‘side view’ of a layered image in accordance with the invented method, with the layers separated into a first image 200 representing a ‘base’ layer, and a second image 202 representing an enhancement layer that adds additional information and enhanced visuals. The first image 200 might be a 2D map built by piecing together the received data 106 such as video footage into a panoramic image, as is already known in the art, providing an essential foundation for the novel contribution provided by the invention herein described. The second image 202 is based on processing and analysis of the received data 106 and adds enhanced visuals, further information about the area, and/or algorithmic analysis; providing this layer locally and allowing the local user to select what gets enhanced and how on this layer is unknown in the art. The example second image 202 as presented in FIG. 2 includes enhancements such as a 3D model of a building 204 that was barely visible in the landscape of the first image 200; stats 206 regarding the building and derived either from a lookup (if info about the building is available publicly on the web for instance) or from a software algorithm scrutinizing the raw visual data closely and counting windows and doors; an algorithmically-derived advised route 208 for best approaching the building 204; and a feature label 210 applied to the uncreatively-named and fictional Mt. Smoky located nearby. The second image 202 might also ‘color in’ further detail or selectively sharpen features on the map, overlaying or replacing all or part of the original image with an enhanced version; in the example here, one might observe that overlaying this second image 202 would incrementally boost the sharpness and contrast values of the raw and unedited photo of image 1. In a preferred embodiment of the invented method, the second image 202 is overlaid with the first image 200 to build an enhanced screen view 108, as presented in FIG. 2. In other embodiments, the second image 202 might be displayed alone, or the first image 200 and second image 202 might be displayed side-by-side in a format such as a split-screen, or even on two displays with one display presenting each image by means for doing so already known in the art of device display sharing, such as one might commonly use to attach two monitors to the same computer or to share one's screen display to another person's device while the devices are connected and communicating with each other. Finally, one should note that this example is oversimplified, drawn using fairly basic tools, and only for conceptual explanation, and be encouraged to imagine the second image 202 as drawn with sophisticated 3D graphical drawing software instead.

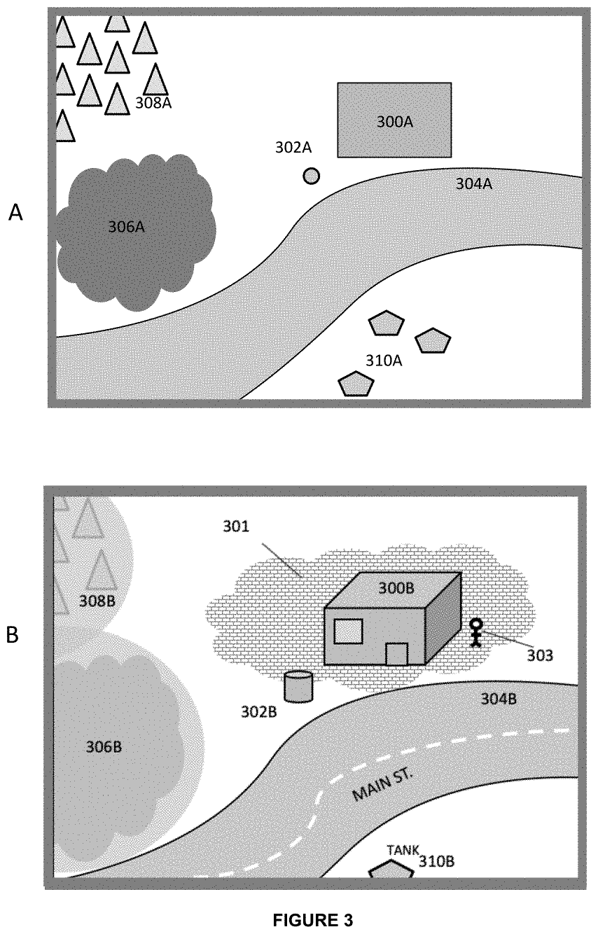

Referring now generally to the Figures and particularly to FIG. 3, FIG. 3 is a pair of very simple stick-figure diagrams representing two video images of the same example fictional landscape. It should be noted that the invented method is applied to high-resolution video data, not stick-figure drawings, and this is only a remote approximation to demonstrate concepts.

Picture A represents an unfiltered, unenhanced image of the landscape, such as the invented method might receive as input data 106 or present as the first image 200. Visible are a building 300A with a smaller object 302A next to it, beside a road 304A. Down the road are a small lake 306A, and a forest 308A. Across the road are a few smaller objects 310A. This image does not give emphasis or uneven attention to any particular feature, but simply shows the overview of all the data, in equal levels of detail. This might be considered as either an instance of the first image 200 (with no second image 202 to enhance it) or a view of an unenhanced image as offered by prior art.

Picture B is an example in which several of the enhancement options available in use of the invented method have been overlaid in a selective enhancement of the same image. This might be contextually considered as an instance of a screen view 108 with the invented method applied, wherein the basic first image 200 shown in Picture A has been enhanced with an instance of the second image 202 derived from the same data as Picture A. First, this example elects to assume for the sake of explanation that the building 300B and the terrain 301 surrounding the building 300B were designated by some user 110 as an area of interest and are therefore presented in more detail; the ‘map’ has been (optionally of course) ‘zoomed in’ on this feature and more computing power is allotted to presenting this portion of the image in the most detail available from the content of the raw data and analyzing this area further. Visible now at this higher level of detail is the texture of the surrounding terrain 301, a window and door on the front of the building 300B, and a newly-revealed person 303 standing near the building 300B. Additionally, 3D effects have been applied, re-drawing the building 300B and the canister 302B next to the building 300B as three-dimensional objects. In this example, the user 110 also specified that the lake 306B and the forest 308B are less relevant; the ‘greying out’ over these areas in Picture B is indicative of a lower level of detail and fewer computing resources expended on these elements of the image. Additionally, the user 110 has toggled a view in which named landscape features that can be looked up, such as roads, are labeled with their names; the label “MAIN ST.” has accordingly been applied to the road 304B, which is also redrawn at a higher level of detail and now has a center line. In this example, the user 110 has also enabled a filter to automatically highlight certain features anytime they are identified within a landscape, which in this example might just be about to save his or her hypothetical life; in Picture B, the one of the objects 310B still visible across the road from the building 300B has been identified by the software and labeled as a ‘TANK’, which new information may prompt the user 110 to accordingly expand the field of view or modify his or her selection of which landscape features are being emphasized. Without the viewing support the present invention makes available, it might've been left up to the user 110 being fortunate enough to squint just right and identify the objects 310A as tanks instead of rocks.

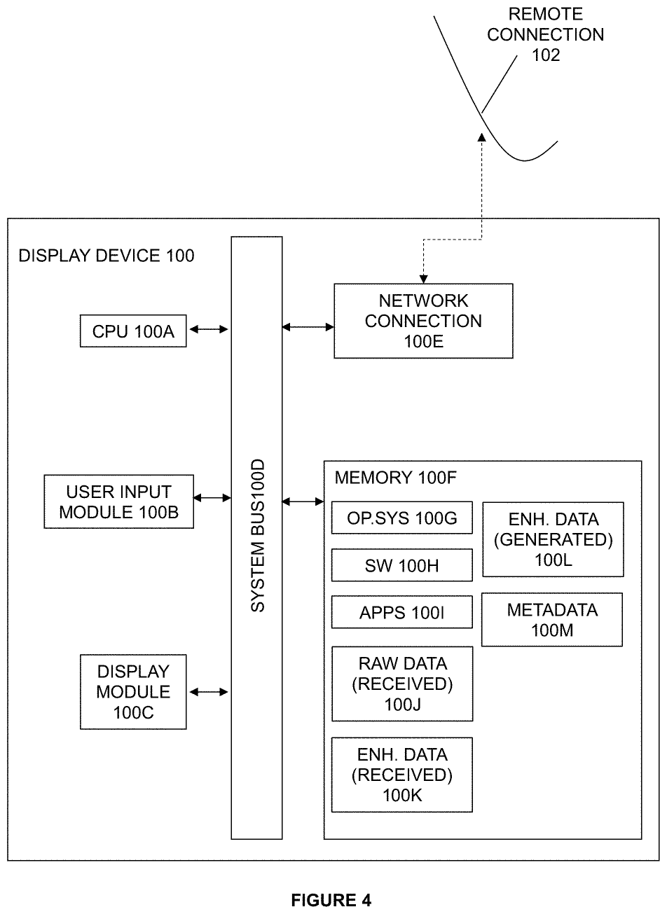

Referring now generally to the Figures and particularly to FIG. 4, FIG. 4 is a block diagram of the device 100, wherein the device 100 comprises: a central processing unit (“CPU”) 100A; a user input module 100B; a display module 100C; a system bus 100D bi-directionally communicatively coupled with the CPU 100A, the user input module 100B, the display module 100C; the system bus 100D is further bi-directionally coupled with a network interface 100E, enabling the device 100 to receive wireless communications via the remote connection 102; and a device memory 100F. The system bus 100D facilitates communications between the above-mentioned components of the device 100. The device memory might include an operating system 100G as required by the hardware and software environment of the device 100, such as WINDOWS XP™, or WINDOWS 8™ operating system marketed by Microsoft Corporation of Redmond, Wash.; a LINUX™ or UNIX™ operating system such as Ubuntu 19.10; or MacOS Mojave 10.14.6 or iOS 13.2.2 as marketed by Apple, Inc. of Cupertino, Calif. Additionally, the device memory 100F will include at least software 100H capable of and adapted to implementing the invented method on the device 100, and may also include additional supporting applications 1001. The device memory 100F also includes at least some storage space for data being processed or used to process other data, including: raw data 100J comprising a local copy of data 106 received from an external source such as a drone 104 or remote processor 112; preprocessed enhanced data 100K received from an external source such as a drone 104 or remote processor 112; enhanced data 100L generated locally; and/or metadata 100M such as a database with names of local landmarks or other relevant lookup information that might be useful for enhancing data as described by the invented method.

The device 100 and its hardware and software components might be or comprise any computing system known in the art suitable for receiving and processing video data 106, providing an input means for the user 110 to control what is shown, and displaying the screen view 108, as recited in the invented method. A preferred embodiment would include a tablet-like device 100, such as an iPad™ as marketed by Apple, Inc. of Cupertino, Calif.; the Samsung Galaxy Tab S6 as marketed by Samsung Electronics America, Inc. of Ridgefield Park, N.J.; or other suitable tablet device known in the art. It should be noted that the invented method could even be applied using a less-portable device such as a laptop computer or even a desktop workstation, and the limiting factor would simply be portability (both physical and in software) and the logistics of carrying around any such equipment.

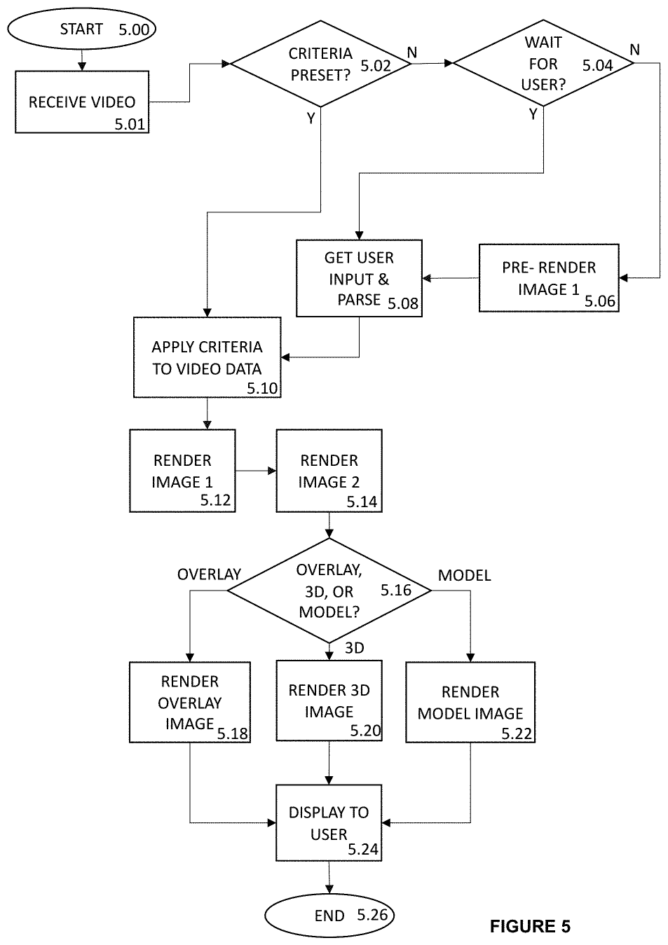

Referring now generally to the Figures and particularly to FIG. 5, FIG. 5 is a flowchart presenting a broad overview of the invented method as enacted on a mobile device 100 receiving video data 106 and selectively building a screen view 108 for a user 110.

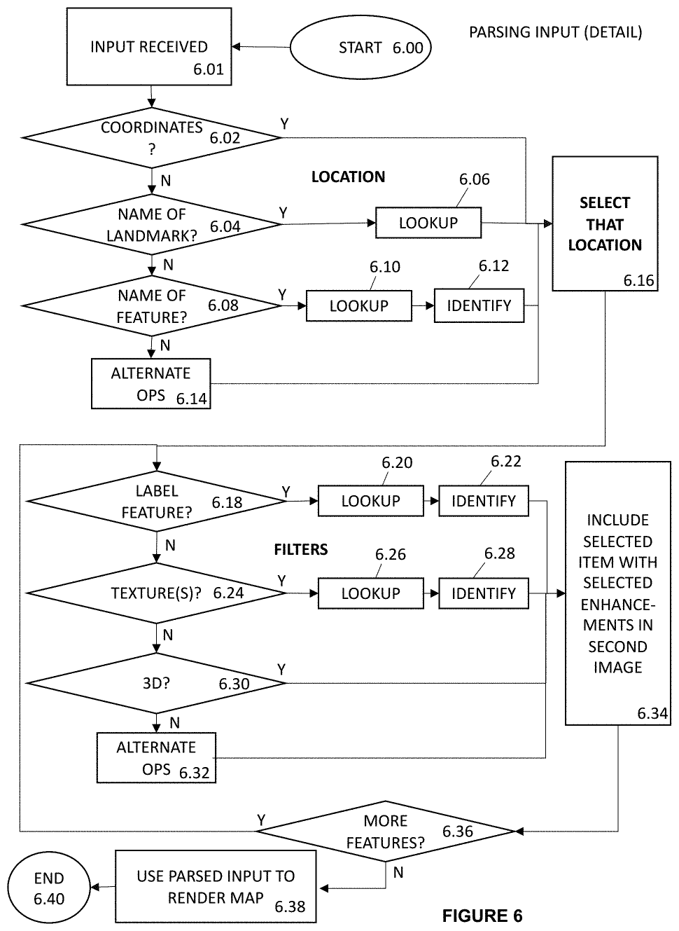

In step 5.00 the process begins, with video data 106 being received in step 5.01. It should be noted that, while in preferred embodiments one or more RC drones 104 might be supplying this video data 106 from overhead reconnaissance flights as described herein, the device 100 is the only essential computer element claimed by the invented method, and all that the invented method requires is some suitable source of video data 106. In fact, a good way to test this method in development might be to have ‘canned’ video data 106 transmitted by a server, so the method of processing can be tested and debugged without changing the dataset to which the processing is applied. Further, additional embodiments of this method include video data preprocessing done elsewhere and then transmitted to the user's device for refining and display, as presented in FIG. 6; that aspect of the invented method could easily include one or more servers, drones, or other devices from which the data finally proceeds to the user's device 100. From the perspective of this flowchart and this method, we don't ‘care’ where the data 106 came from, we just receive the data 106, in whatever processed or unprocessed state, and apply the invented method.

In step 5.02 we select based on whether there are already preset criteria for the selective enhancement (and user input is not required). This may be, for example and not limited to, a ‘favorite’ mode already preset by the user 110, a default configuration preprogrammed into the device 100, or even a preprogrammed mode selected algorithmically by the device 100 software as the best preset display for conveying the material received. Some examples of useful generic preset modes might include, ‘always de-emphasize heavy forest areas and emphasize buildings and roads’, or ‘always center the image on the device's current location’, or ‘label major landmarks whenever possible’. If the user 110 already had this preset, the device 100 doesn't need to wait around for the user 110 to select viewing criteria, in order to get started on assembling that, and the user 110 doesn't have to take time or attention to make selections so the computer can get to work.

If the criteria are preset such that user input is not required for the device to determine what to display, then the method can skip user input entirely. Else, in step 5.04, we select based on whether to wait for the user 110 or to do preliminary processing work (to the extent possible) in step 5.06, prior to receiving input from the user 110. For instance, even before receiving a command from the user 110, the device 100 could get started with basic processing that would be required regardless of the user's selections and save some time, or might present the whole map then wait for the user 110 to select the portion of the image he or she wants to look at just now. Providing the first image 200 for the user 110 to look at when selecting enhancement criteria might be a beneficial feature for a user interface. In this way, the device can complete at least some of the computing work of processing the image without (inefficiently) waiting around for the user's input, then receive a user command and adjust, or continue building where that other process left off in view of the input criteria.

Whether we waited for user input or started working on the image first, in step 5.08 user input is received and parsed. Regardless of whether the criteria for selective viewing are preset or user-originated, once both the settings and the raw video data 106 are available, the criteria can be applied to the video data in step 5.10 and the device 100 can process the first image 200 in step 5.12, or complete the processing if some work has been done already, resulting either way in the first image 200 being fully processed and ready to include in the final product.

In step 5.14 the device 100 proceeds to build the second image 202, the enhancement layer. The second image 202 can be combined with the first image 200 in different ways, in different embodiments of the invented method; in step 5.16 we select which way to combine the images, by overlaying the second image 202 over the first image 200 in step 5.18, producing a 3D combined image in step 5.20, or by drawing a graphical model in step 5.22. Regardless of which flavor of image is being presented, once the screen view 108 is complete and ready to display, the screen view 108 is displayed to the user 110 in step 5.24 and in step 5.26 the method is complete.

Referring now generally to the Figures and particularly to FIG. 6, FIG. 6 is a flow chart presenting a simplified example model of a process for parsing settings input that directs selection of view options. This entire flowchart may be considered a ‘zoom-in’ on step 5.08.

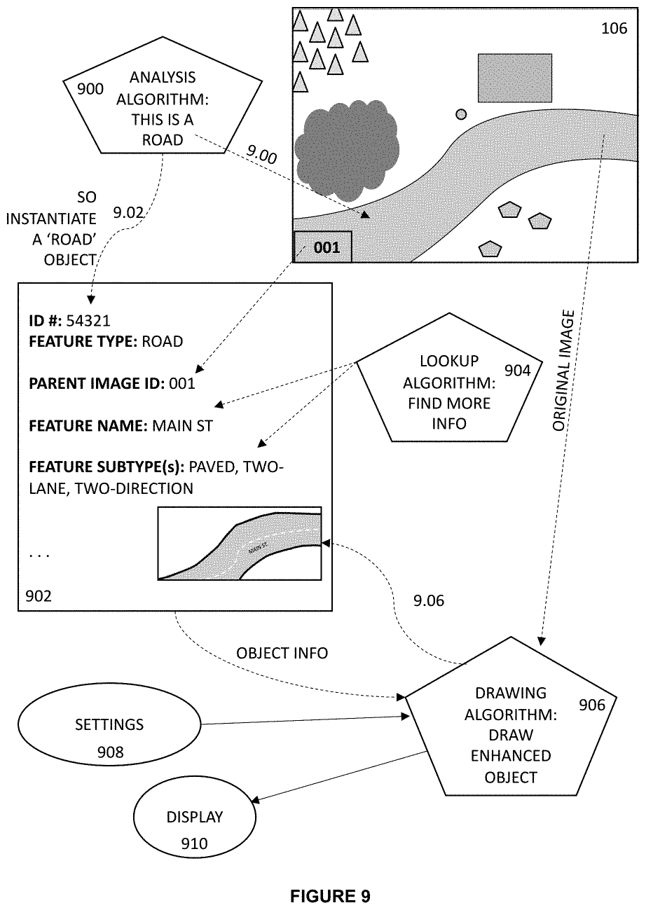

In step 6.00 the process begins, and in step 6.01 input is received, such as from a user 110 selecting using a device interface. It is understood that the exact kind of user interface used is not important and might be but is not limited to a command line accessed by a keyboard, a ‘point-and-click’ menu, an interface that accepts and parses verbal commands, a few buttons on the side of the device, a touch-screen, or any other means for user input known in the art that is suitable for providing user input for implementing the invented method as described herein. Additional discussion regarding interfaces and means for user input can be found in the text for FIG. 9. Further, this single step 6.01 incorporates any computation that may be required to turn the user's words, commands, button-presses, etc. into semantic computer language; the flowchart of FIG. 6 is a decision-making tree, and does not include the foundational intake, translation, parsing, and error-handling steps that must be included almost anywhere there's human user input. This flowchart assumes that this work has already been done by the end of step 6.00 and the computer has been given appropriate input relevant to this method and this input has already been translated into one or more commands in a semantic format the computer can act upon.

Some of the settings options available pertain to what location being viewed, such as latitude/longitude or other map coordinates, a certain named landmark (“show me the Eiffel Tower”), or a feature of interest (such as a tank). In the flowchart presented herein, the invented method determines first whether the user 110 has requested that the view be of a specific location or feature. Step 6.02 checks whether the input is a set of coordinates such as longitude and latitude, or something else, such as an index number, that's already actionable for a computer to identify without a lookup to turn a name into a number first. If so, no further lookup is required. If not, step 6:04: is the input a name, like a landmark? If so, step 6.06: look up the name and quantify this point as an actionable value for the computer to use; for instance, “Eiffel Tower” might become 48.8584° N, 2.2945° E. If the user input isn't the name of a landmark that can be looked up and matched to coordinates, we keep determining what the user 110 asked for. Step 6.08 checks whether the request might be for a feature of interest, for example a river or a tank. Perhaps, for instance, the user directs the device to do something like ‘show me that building directly north of where I am’ or ‘find the nearest tank(s)’. That requires the invented method to both (step 6.10) look up what a building or a tank looks like, and (step 6.12) identify instances of that object in the raw data 106 as directed, to determine what location the user 110 wants to view or enhance, and adjust accordingly. Any person skilled in the art will recognize that these three possibilities do not constitute an exhaustive list of means for selecting a location or feature to view or enhance, and adding further capabilities and interface options for identifying locations and objects would be obvious to include as convenient for the interface; step 6.14 is a placeholder for alternative additional options, representing where further possible options would be placed to continue this list as preferred. Some additional possible options for selection of a location might include accepting input in the form of the user dragging a box on a visual representation of the terrain, around the area they want to select, or pressing a button; further discussion of possible user interfaces is additionally presented in FIG. 9 and accompanying text. It's understood that, depending on the features added in this slot at step 6.14, a lookup may or may not also be required, or the software may or may not also have to locate something in the raw data 106 before the filter can be applied; these steps are not shown. Regardless of how the location to select is identified, and whether the device needs to do a lookup or search the data to match the user's request to a point on the map, at step 6.16 the invented method has determined what location to display to the user 110 or select for enhancement.

The second half of the diagram of FIG. 6 pertains to determining how the view should be enhanced, applying filters such as labels, highlighting, color-coding, or individually drawn objects such as 3D models. The user 110 might, in step 6.18, opt for the device to mark certain features; for instance, highlight all the tanks or label them ‘TANK’, or label the local streets with their names, or show maximum detail for a feature on the map such as a building. Again, the implementing device 100 might need to, for example, (step 6.20) look up what a ‘tank’ looks like and (step 6.22) find all of those and flag them to be appropriately included in the enhancement content of the second image 202. If the user isn't looking for a named feature, they might have specified a texture (such as dense forest, as a practical example) or a combination of textures. As a practical example, a soldier using the device to implement the invented method might direct that the device not waste compute power or time analyzing a dense forest in beautiful, leaf-perfect detail, but instead focus on open ground and leave the forest less-known; the device would need to identify ‘forest’ in the image, and apply that kind of condition to all the areas identified as ‘forest’. Similarly, the user might select a combination of textures; blur the dense forest or deep water, emphasize the open ground or road to show where the paths and sightlines are. Step 6.24 checks whether the user is specifying this kind of condition, and if so, (step 6.26) looks up (to continue the example) what ‘dense forest’ looks like, and (step 6.28) identifies the dense forest in the image being processed, so the filter can be applied as directed. Likewise, the user might specify a specified combination of textures, (step 6.32) looks them up, and (step 6.34) identifies them on the map image for filtering. Step 6.30 offers an option for presenting the selected map object as 3D. As with step 6.14, step 6.32 is a placeholder representing additional further options for image enhancement, as anyone will recognize that the list herein presented is not exhaustive and further viewing options could obviously be included and would belong at this point in the flow chart. For instance, a device might include view options specifiable by a user for improved accessibility, such as a minimum font size for any labels shown; additionally: a filter for higher contrast or sharper textures, a filter to keep the screen at a certain brightness or hue to preserve night vision or be less visible in the dark, historical data of the same location from other sources, a visual representation of sight lines such as sniper field of fire, notations regarding distances or number of doors or windows in a building, color tinting to distinguish between friendly and hostile units, a ‘you are here’ marker, a recommended path to get from one point on the map to another, and one skilled in the art could easily come up with many more possible image enhancements that could usefully be included. Step 6.32 stands in as a placeholder for where in the procedure these additional options would collectively fit, as an indefinite continuation of the list (options 1, 2, 3 through N). It's understood that, depending on the feature, a lookup may or may not also be required, or the software may have to locate something on the ‘map’ before the filter can be applied; these steps are not shown. Once the information needed to apply whichever filter is obtained, in step 6.34 the software has been directed to apply the selected filter to the selected object when presenting a screen view 108 for the user 110 to look at. Step 6.36 allows for a loop of applying multiple filters; unlike with selecting a location (the user can only ask for one selection at a time to apply one or more enhancements to, or only view one location at a time), multiple filter options could be specified. If step 6.36 is true we keep going through the steps for applying a filter until all of them are applied to the specified selection. When step 6.36 is false, the device 100 has all the enhancement settings selections for the selected location or object. The user might enhance multiple objects individually this way, or apply a ‘blanket’ enhancement to the map of a given area at a given location. In step 6.38 this gathered information is included in the directions for producing the second image 202. The process ends at step 6.40.

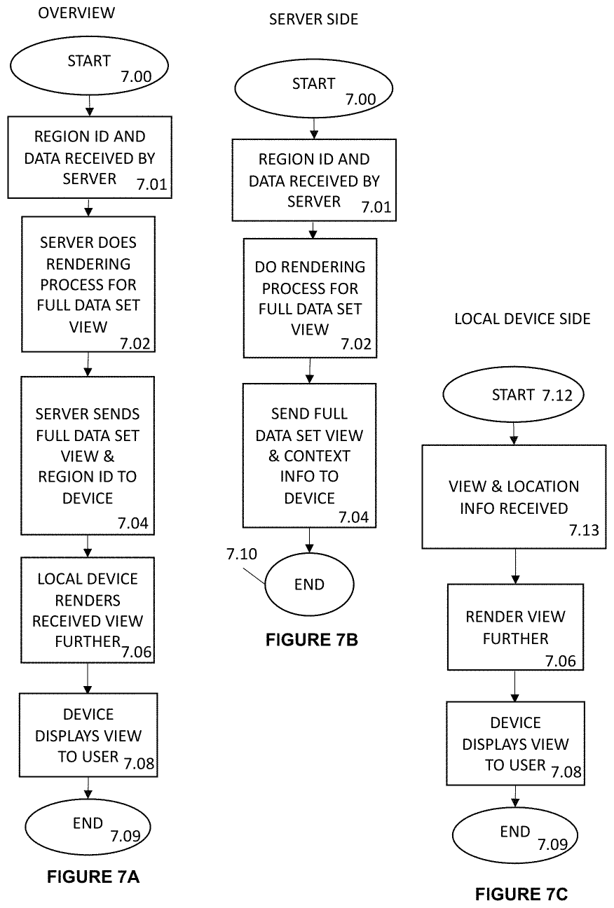

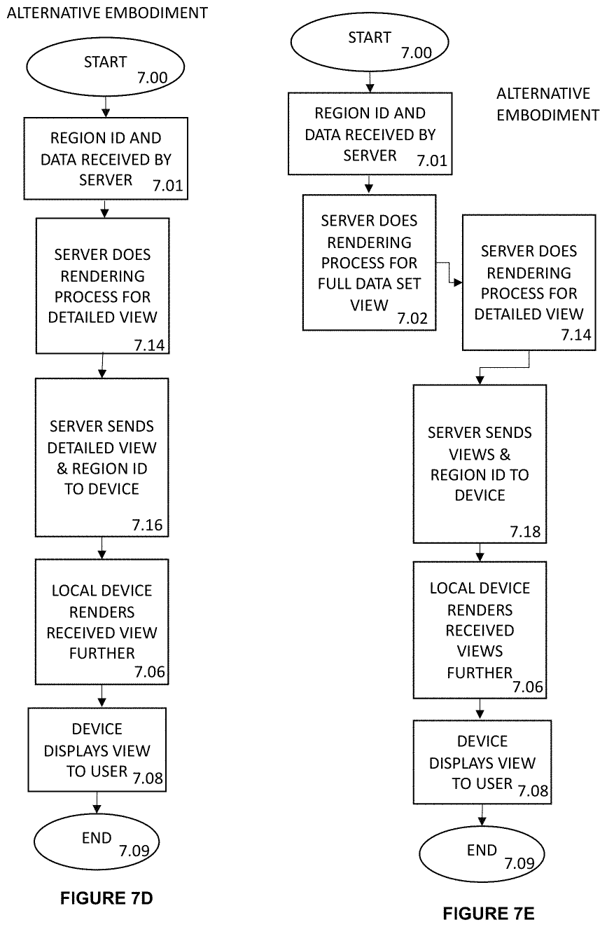

Referring now generally to the Figures and particularly to FIGS. 7A through 7E, FIGS. 7A through 7E are flowcharts presenting the method for data processing as done by both a remote processor 112 (in the charts also called the server) and a device 100, rather than the device 100 alone. FIG. 7A shows an overview of this process, and FIG. 7B presents two smaller flowcharts representing each ‘side’ of the same transaction.

In the flowchart of FIG. 7A, the process begins with step 7.00; in step 7.01 the server first receives some raw video data 106A and a piece of data identifying the region from which the video data originates. If the same server is fielding raw video data 106A coming in from multiple regions and going out to multiple devices 100 located in those different regions, this ID token is crucial. The data about the region may also include lookup information regarding names of local landmarks (necessary for step 6.04, 6.08, or 6.18 of the image production) or other important lookup information about the region, passed around along with the raw video data for use by whatever computer is processing the images. The remote processor 112 does at least part of the processing work for producing the first image 200 in step 7.02 (such that the device 100 has less work to do upon receiving the video data 106B from the remote processor 112). This may include applying default display settings or following the direction of a supporting technician directing the remote processor to apply certain settings as judged by the technician to be appropriate, or to ‘show’ one or more people on the ground, each with their own device 100, certain preferred views. The at least somewhat processed video data 106B is then sent on to the device 100 in step 7.04, along with forwarding the region ID information. It should be noted that sending video and data regarding the same region where the device 100 is currently located would be a sensible application.

When the device 100 receives the video data 106 and region ID information, there may still be further processing to do on the device 100; there may be local settings to apply to the foundation begun by the remote processor 112, or the device 100 may need to do whatever work is necessary to instantiate the data received as an image to display on the specific screen belonging to the device 100. In step 7.06 the device 100 does whatever processing work is still necessary to turn the video data 106B received from the remote processor 112 into a selectively-enhanced screen view 108 for the user 110 to look at. At step 7.08 the image is displayed to the user, and at step 7.09 this process is complete.

In FIGS. 7B and 7C, the same process is presented as two separate flowcharts, one for the remote processor 112 side (server side) and one for the device 100 side. The server-side flowchart begins with the same step 7.00 as shown in FIG. 7A; the remote processor 112 receives raw video data 106A and a region ID in step 7.01. The process continues with the same step 7.02, consisting of the remote processor 112 doing its generic or partial data processing, and step 7.04, passing the at least partially-processed data along to the device 100. As this point, step 7.10, the remote processor 112 is done with its work. Moving over to FIG. 7C, meanwhile the device 100 begins its work at step 7.12, and in step 7.13 receives the data package sent by the remote processor 112 in step 7.04. The device 100 may further process the material received as necessary, in step 7.06, then present the finished result to the user at step 7.08. At step 7.09 this process is complete.

In the flowchart of FIG. 7D, an alternative embodiment of the same process is presented, wherein the remote server 112 at least partially generates the second image 202 and sends this pre-completed work to the device 100. The process begins with step 7.00; in step 7.01 the server first receives some raw video data 106A and a piece of data identifying the region from which the video data originates. The remote processor 112 does at least part of the processing for producing a selectively enhanced second image 202 in step 7.14 (such that the device 100 has less work to do upon receiving the video data 106B from the remote processor 112). This may include applying default display settings or following the direction of a supporting technician directing the remote processor to apply certain settings as judged by the technician to be appropriate, or to ‘show’ one or more people on the ground, each with their own device 100, certain preferred views. The at least somewhat processed video data 106B is then sent on to the device 100 in step 7.16, along with forwarding the region ID information.

When the device 100 receives the video data 106B and region ID information, there may still be further processing to do on the device 100; there may be local settings to apply to the foundation begun by the remote processor 112, or the device 100 may need to do whatever work is necessary to instantiate the data received as an image to display on the specific screen belonging to the device 100. In step 7.06 the device 100 does whatever processing work is still necessary to turn the video data 106B received from the remote processor 112 into a selectively-enhanced screen view 108 for the user 110 to look at. At step 7.08 the image is displayed to the user, and at step 7.09 this process is complete.

In the flowchart of FIG. 7E, an alternative embodiment of the same process is presented, wherein the remote server 112 at least partially processes both the first image 200 and the second image 202 and sends this processing work to the device 100. The process begins with step 7.00; in step 7.01 the server first receives some raw video data 106A and a piece of data identifying the region from which the video data originates. The remote processor 112 does at least part of the processing for producing the first image 200 and the second image 202 in step 7.02 and step 7.14 respectively as shown (such that the device 100 has less work to do upon receiving the video data 106B from the remote processor 112). This may include applying default display settings or following the direction of a supporting technician directing the remote processor to apply certain settings as judged by the technician to be appropriate, or to ‘show’ one or more people on the ground, each with their own device 100, certain preferred views. The at least somewhat processed video data 106B is then sent on to the device 100 in step 7.18, along with forwarding the region ID information.

When the device 100 receives the video data 106B and region ID information, there may still be further processing to do on the device 100; there may be local settings to apply to the foundational processing work begun by the remote processor 112, or the device 100 may need to do whatever work is necessary to instantiate the data received as the screen image 108 to display on the specific screen belonging to the device 100, such as adjusting for the screen size. In step 7.06 the device 100 does whatever processing work is still necessary to turn the video data 106B received from the remote processor 112 into a selectively-enhanced screen view 108 for the user 110 to look at. At step 7.08 the image is displayed to the user, and at step 7.09 this process is complete.

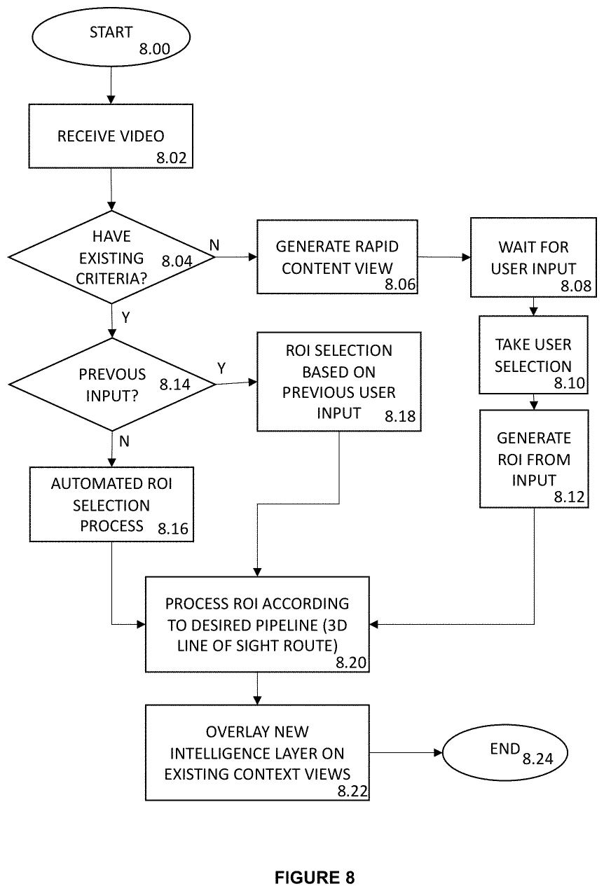

Referring now generally to the Figures and particularly to FIG. 8, FIG. 8 is a flow chart presenting an additional alternate embodiment of the invented method (hereinafter, “the first alternate method”) as enacted on a mobile device 100 receiving video data 106 and selectively enhancing the screen view 108 for a user 110. In step 8.00, the process starts. In step 8.02, the device 100 receives video data 106 to process and present. In step 8.04, if the device 100 does not already have instructions for how to present the screen view 108, then in step 8.06 a ‘rapid view’ preliminary image is generated and displayed to the user 110, so the user 110 can select his or her view settings in step 8.08. The device 100 takes the user input in step 8.10, and in step 8.12 uses the settings provided by the user to define a region of interest (hereinafter, “ROI”) for enhancing the screen view 108. On the other hand, in step 8.04 if the device 100 already has instructions for how to present the screen view 108, these instructions may be previous user input or programmed-in automation. In step 8.14 if the prior instructions are old user input, then in step 8.18 the ROI is selected based on that previous user input. Otherwise, in step 8.16 the device 100 follows an automated process to select the current instance of the ROI. Regardless of how the ROI was defined, in step 8.20 the ROI is processed along with the raw video data 106 to produce an informational overlay for the end result screen view 108. In step 8.24 the first alternate method ends and the mobile device 100 returns to other computational processes.

Referring now generally to the Figures and particularly to FIG. 9, FIG. 9 is a process chart displaying certain other optional aspects of yet additional alternate preferred aspects that may be included in various alternate preferred embodiments of the invented method, that may be included in singularity, combination, and/or totality. Portrayed here is a graphical representation of a software implementation for how an enhanced or augmented instance of a topographical feature (such as a road, in this example) of the raw video data 106 might be picked out of the data, encoded in software as an object for possible further enhancement, and possible metadata looked up and attached to the same object. This process chart is designed with object-oriented software coding practice in mind, as an example of how raw video data 106 might be converted into a ‘model’ of the same landscape comprised of interconnected objects in an object-oriented software environment, for purposes of generating augmented images such as 3D objects and labeled landmarks. In step 9.00, an analysis algorithm 900 surveys the raw video data 106 received to be processed for an enhanced display. This might be a machine learning algorithm or similar, any suitable for picking out visual features: ‘that looks like a road’, ‘this feature matches the pattern for being an X model of tank’. For each feature this analysis algorithm finds in the raw data 106, a new instance of a predefined object should be added to the informational model the software is building of this landscape. Object-oriented programming is well-known in the art;

one non-limiting example of an object-oriented programming structure that might be usefully implemented here is a class in C++. In that instance, it might be advisable to write a class wherein each instance represents an object found in the landscape, and identifiable subclasses such as roads, buildings, lakes, tanks, and so on would inherit from that catch-all class. The object 902 presents an example of an object structure containing data for the road that was found by the analysis algorithm 900 in this example. This example object structure 902 includes as some example member variables: a unique identifier 902A (as a good organizational practice in any field); a type field 902B (which could be usefully implemented as an enumerated value) indicating what kind of landscape object this is; a parent identifier 902C for linking back to the raw data 106 that this object was found in; a feature name 902D; feature subtypes 902E; and of course these member variables are just a few non-limiting examples and not even everything that should probably be coded into this object structure 902, so the ellipsis 902F indicates that this list continues. Some examples of further member variables to include might be positional coordinates within the parent image, latitude/longitude coordinates for this feature (if this required geolocational data isn't available elsewhere in the program, as this information will probably need to be recorded and accessed somewhere), and linkages between this object as found in this dataset, and the same object as found in a different dataset, such that the computer is ‘smart’ enough to make use of having two overlapping datasets of the same area rather than just having parallel duplicates that don't connect. Another member variable might be either a nested object or a pointer to an object storing the enhanced image of this feature or data for generating same, such that this object can be queried to provide a fully-enhanced image of ‘its’ piece of the model. Once an instantiation of the analysis algorithm 900 determines in step 9.00 that there is a road in the raw data 106 and a road object should be added to the corresponding software model as indicated in step 9.02, the data fields of the newly created object need to be populated. The raw data 106 would also ideally be part of an object which could be queried for information such as its unique identifier, where in the world the video was captured and what date and time, and of course the location in memory where a copy of the data itself may be found; whatever this object's unique identifier was, would be copied over to the new object 902 so this object can ‘cite’ its source. The unique identifier 902A for the object 902 itself would be automatically generated at the moment the object is created, and the feature type 902B would be given by the analysis algorithm 900: ‘this is a road’, ‘that is a building’. All that information, as well as the feature's location in the image containing it, can be generated as part of creating the object 902: this is a road, found in data image 001 at X over and Y down, make a new object and assign a number. Then, if this feature is of interest and the model wants to incorporate more information about it, the program might ‘flesh out’ this object further by calling a lookup algorithm 904, such as a function or set of functions (or method or set of methods within a dedicated object) that queries a database, using the geographical location to pinpoint a spot on the globe and querying information about that spot: in English, such a query might be phrased as, ‘we found a road at X longitude and Y latitude, is there a street name in the database for a road located there?’ In step 9.04 the lookup algorithm 904 provides its findings for incorporation into the object 902; in addition to a name for this road, the lookup algorithm 904 might be able to provide information such as whether the road is one-way, how many lanes the road has, or whether or not it's paved, if such information is accessible and relevant. A sophisticated analysis algorithm 900 might also be capable of providing information such as whether the road has multiple lanes, or even determine which directions traffic travels on the road through observing enough of the video data to ‘watch’ some traffic traversing the road. This is only a small example of relevant information that might be provided to improve the model by means of a lookup algorithm 904. Additionally, other supporting algorithms might be employed as considered useful to improve the objects in the software model; this simple example should be considered explanatory and exemplary, rather than limiting. Step 9.06 presents an algorithm for drawing an ‘enhanced’ road feature (for instance, 3D) and including access to the assembled image as part of the object also, such that the program may query the object as an element of the software model and have the object produce the enhanced road image or the means for assembling same with a minimum of additional processing. This drawing algorithm 906 would import the original visual data, as shown by the arrow, and also use information already stored by the object 902 at whatever level of sophistication, such as a feature name for labeling the road image, or a feature type to inform the algorithm as to what the image being drawn should look like or what features to make sure to pick out of the raw image and include, such as accurate placement of all the windows and doors on a building. Additionally, whatever display settings 908 have been specified, as described elsewhere at least at FIG. 8, might also inform the drawing algorithm 906.

Now, it should be understood that the graphical resources of the device 100 overall are tasked to produce the screen view 108 for the user 110 to look at; that's the actual image the user 110 sees, and though the graphical representation of the road object of this example might appear in this image, what is under discussion regarding FIG. 9 is the modeling going on ‘behind the scenes’, wherein a simulation model of the landscape is being constructed by analyzing the raw data 106 and bringing in other intelligence such as table information looked up by the lookup algorithm 904. In terms of timing, and in terms of how much of this ‘fleshing out’ work is actually done for any given feature, these factors are meant to be controlled externally, by user settings as to what is of interest, or by processing constraints imposed by the hardware. In an environment of unlimited hardware resources, the software might ‘flesh out’ everything, behind the scenes, then instantly be able to display whatever part of that the user was actually interested in; or if the user specified everything, the program might flesh out everything, even in a limited processing environment, but the process might take a while or run out of memory. These are hypothetical extremes, though, and chances are that in a majority of cases the processing power will be budgeted and parceled out to boost different objects' graphical quality or informational comprehensiveness as directed. Additionally, the algorithms' analysis of the raw data and provision of additional lookup information or supporting functions might be independent of or connected to the user's directives; in a situation where the processing power is limited, one way to budget is to not do extra work before finding out what is actually required, while in a scenario of unlimited hardware resources, of course it would be more convenient for the user if everything were done in advance because there would be no waiting for things to load.

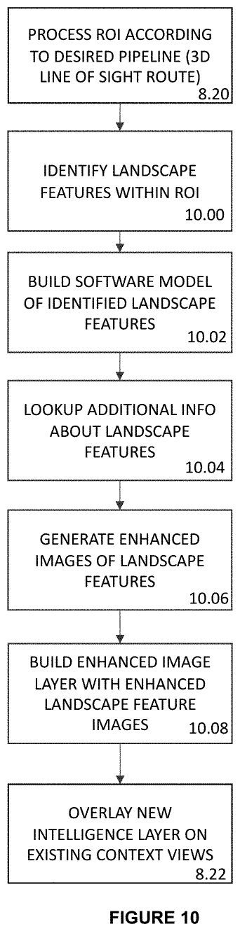

Referring now generally to the Figures and particularly to FIG. 10, FIG. 10 is an addendum to the flowchart of FIG. 8, wherein additional incremental and optional steps are inserted between steps 8.20 and 8.22. FIG. 8 presents various means for specifying the region of interest (ROI), culminating in the ROI having been specified by step 8.20 and used to overlay an additional intelligence layer on existing context views in step 8.22. In FIG. 10, additional detail is presented regarding a possible method for assembling a preferred embodiment of such an intelligence layer or overlay. In this embodiment, extra information and graphical effects (such as 3D images of features on the landscape) are overlaid on top of the regular image as captured, to create an augmented or enhanced screen view. One optimal way to put together this kind of overlay might be to build a software model of identifiable features of interest located within the ROI, using software object structures like the ones detailed in FIG. 9. This software modeling would take place between steps 8.20 and 8.22 of FIG. 8 as discussed, to assemble the overlay for inclusion in step 8.22. In step 10.00, one or more features of interest (e.g. buildings, roads, waterways, rocks, tanks . . . ) are identified within the ROI specified by the user 110; this would be analogous to step 9.00 of FIG. 9 and accomplished by some suitable analytical algorithm 900 such as a machine learning algorithm trained to pick relevant landscape features out of an image and identify them. In step 10.02, the identified features are used to construct a software model of the landscape, such that an overlay can be generated wherein the individual identified features might be visually altered or enhanced, or labeled with additional information. In step 10.04, additional information regarding landscape features might be added or looked up; this might include labeling roads and landmarks that can be identified in a geographical database. In step 10.06, enhanced images of landscape features may be generated, such as 3D images. In step 10.08, the program does whatever work is necessary to ‘bring all of the pieces together’ into one or more enhancement layer(s) 202 that can be cleanly overlaid onto the basic first image 200.

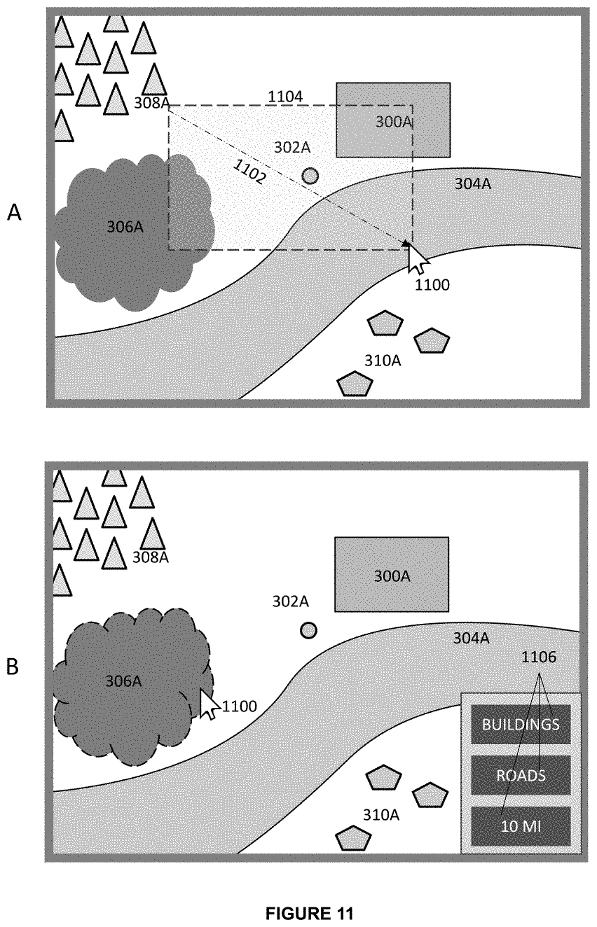

Referring now generally to the Figures and particularly to FIG. 11, FIG. 11 is a diagram presenting a few different user interface means for selecting a region of interest (ROI). Anyone skilled in the art, and most everyday users, will understand that these user interface implementations are fairly standard and intuitive for regular computer users; nothing is novel or nonobvious about the user interface by which means a user would interact with the device 100 in executing the invented method, save perhaps the exact labeling of buttons or similar obvious details that often vary between various software applications or hardware devices. In Screen A as labeled in FIG. 11, a mouse cursor 1100 is being moved in a ‘click-and-drag’ motion 1102 to select a rectangular area 1104, wherein the mouse button is held down at one corner of the rectangle, kept down as the user drags the mouse pointer diagonally across the area to select, and the mouse button is released at the opposite corner of the rectangle to stop expanding the selection area. A similar selection method could also be implemented by a finger on a touch screen, wherein the finger first touches the screen at one corner of the rectangle being described, is moved across the screen diagonally to expand the selection area, and is raised from the screen to stop expanding the selection area. Additionally, an area of the image could be selected by means such as keying in coordinates or selection criteria using a keyboard or voice recognition, clicking on or pressing a button 1106 or menu option corresponding to a predefined selection provided by the interface (e.g. ‘select all buildings’, ‘select all roads’, or ‘select everything within ten miles of where I am’, as some reasonable preset options shown here). Additionally, the user might select one or more features of interest by clicking on or touching (on a touch screen) those features; for instance, in Screen B as labeled in FIG. 11, the mouse cursor 1100 is selecting the lake 306A by clicking (or double-clicking, as the developer decides is suitable for an intuitive interface) on that obvious identifiable feature, and the software is recognizing that mouse click as being positioned at an obvious landmark, and selects that object as shown. Further, on a touchscreen one might touch simultaneously with multiple fingers to ‘grab’ an area or select multiple landmarks, if the interface is configured to accept this kind of input; or a fingertip or stylus on a touchscreen might ‘circle’ an area of interest. The user interface might be operated with verbal commands, such as “show me the Empire State Building and all streets within a mile of it” or a combination of verbal and mouse or touch, such as selecting an object then saying, “show me all rivers within a mile of the current selection”. The interface may also provide options for applying filters (e.g. label all the roads), deselecting or resetting the selection, or annotating the image. Additionally, it should be noted that displaying a ‘map image’ for the user to look at and make selections on would probably be more user-friendly in most embodiments, but is not strictly necessary. The user might key in map coordinates, press buttons, or specify criteria without having a map to look at, even though both of the images in this figure include a map to click around on. It should be additionally noted and considered obvious that the discussion herein regarding possible user interface means for selecting a region of the screen and other display options is nowhere near exhaustive and should not be construed as limiting. Further, while keyboards, mice, and touch screens are readily accessible examples of user interface embodiments used commonly on a daily basis, a device having none of these and including other means for user interaction instead is easily imagined, and would require the assignment of alternate available controls for doing the tasks relevant to the invented method. As long as some suitable means for providing input is available, the invented method might be implemented on any device capable of running the requisite software, receiving input, and displaying images.

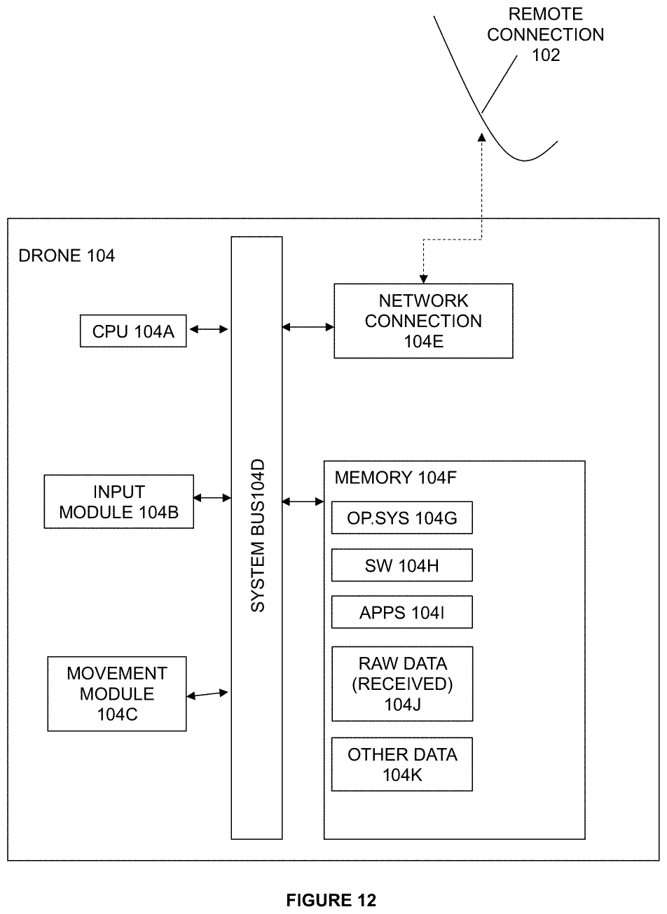

Referring now generally to the Figures and particularly to FIG. 12, FIG. 12 is a block diagram of the computer hardware of the drone 104, wherein the drone 104 comprises: a central processing unit (“CPU”) 104A; a user input module 104B; a movement module 104C; a system bus 104D bi-directionally communicatively coupled with the CPU 104A, the input module 104B to operate a data-gathering device such as a camera, the movement module 104C to receive and enact navigation instructions for moving the drone; the system bus 104D is further bi-directionally coupled with a network interface 104E, enabling the drone 104 to receive wireless communications via the remote connection 102; and a device memory 104F. The system bus 104D facilitates communications between the above-mentioned components of the drone 104. The drone memory 104F might include an operating system 10FG as required by the hardware and software environment of the drone 10F, such as WINDOWS XP™, or WINDOWS 8 ™ operating system marketed by Microsoft Corporation of Redmond, Wash.; a LINUX™ or UNIX™ operating system such as Ubuntu 19.10; or MacOS Mojave 10.14.6 or iOS 13.2.2 as marketed by Apple, Inc. of Cupertino, Calif. Additionally, the drone memory 104F will include at least software 104H capable of and adapted to controlling the movements of the drone 104, and to recording and managing video data and sending it to another device 100 in accordance with the invented method, and may also include additional supporting applications 1041 which might include applications for doing some of the processing, picking out important features, analyzing routes or line of sight, or doing LZ analysis. The drone memory 104F also includes at least some storage space for recorded data, including recorded data 1041 that will be sent on to other devices as raw data 106. Additionally, a moving platform such as a drone 104 already gathering and carrying video data could be used to store, convey, or transmit other data 104K as necessary, which might include metadata regarding the local area or pre-enhanced data assembled elsewhere, or even unrelated materials that just need to be transferred by means of the same drone 104 also being used to provide video input for the invented method.

The drone 104 and its hardware and software components might be or comprise any drone system known in the art suitable for gathering, storing, and sending data 106 such as video data, as recited in the invented method. A possible model of suitable drone might include a Sharper Image DX-5 10″ Video Streaming Drone as marketed by Target of Minneapolis, Minn.; a Foldable Drone with 1080P HD Camera for Adults, Voice Control, RC Quadcopter for Beginners with Altitude Hold, Auto Return Home, Gravity Sensor, Trajectory Flight, 2 Batteries, App Control as marketed by Amazon of Seattle, Wash.; or a DJI-Mavic 2 Pro Quadcopter with Remote Controller as marketed by Best Buy of Richfield, Minn., or other suitable drone-with-camera models known in the art.

While selected embodiments have been chosen to illustrate the invented system, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A method comprising:
a. a local device receiving a data set, the local device having a video display module;
b. the local device receiving a user selection distinguishing a portion of the data set;
c. the local device rendering the data set via the video display module as derived from an application of a first analytics protocol to the data set to generate a first screen image; and
d. the local device integrating enhanced data with the portion of the data set via the video display module as accessed an application of a second analytics protocol to the portion of the data set to generate a second screen image, whereby the second screen image displays the enhanced data.

2. The method of claim 1, further comprising the local device generating the enhanced data.

3. The method of claim 1, further comprising the local device receiving at least a portion of the enhanced data via an external communications network means.

4. The method of claim 1, wherein the second analytics protocol generates a three dimensional representation of elements depicted within the second screen image.

5. The method of claim 1, wherein the second analytics protocol generates a proportional and positionally related representation of (a.) elements depicted within the second screen image and (b.) elements rendered both outside of the second screen image and within the first screen image.

6. The method of claim 1, wherein the local device receives the user selection distinguishing the portion of the data set after rendering the first screen image.

7. The method of claim 1, wherein the user selection distinguishes at least one element of the portion of the data set as an equipment feature.

8. The method of claim 1, wherein the user selection distinguishes at least one element of the portion of the data set as an architectural feature.

9. A method comprising:
a. a local device receiving a data set, the local device having a video display module;
b. the local device interrogating the data set and determining at least one region of the data set that meets a preset criteria;
c. The local device rendering the data set via the video display module as derived from an application of a first analytics protocol to the data set to generate a first screen image; and
d. The local device generating an enhanced data set from the at least one region of the data set via the video display module by application of a second analytics protocol to the at least one region of the data set, and the enhanced data set is rendered to generate a second screen image, whereby the first screen image is overlaid with the second screen image.

10. The method of claim 9, further comprising the local device receiving additional data and integrating the additional data in the application of the second analytics protocol to both the at least one region of the data set and the additional data to generate enhanced data set.

11. The method of claim 9, further comprising
a. the local device identifying the at least one region of the data set to a remote server;
b. the remote server at least partially processing the at least one region of the data set by a fourth analytics protocol to derive a detailed screen image data set; and
c. the remote server transmitting the detailed screen image data set to the local device;
d. the local device applying an element of the detailed screen image data set in rendering the second screen image.

12. The method of claim 9, wherein the at least one region is determined at least partially on a first criteria of not presenting a predefined texture type.

13. The method of claim 10, wherein the at least one region is determined at least partially on a first criteria of not presenting a predefined texture type above a first preset density.

14. The method of claim 9, wherein the at least one region is determined at least partially on an alternate criteria of presenting a predefined texture type.

15. The method of claim 12, wherein the at least one region is determined at least partially on an alternate criteria of presenting a predefined texture type above a first preset density.

16. The method of claim 9, wherein the at least one region is continuous.

17. The method of claim 9, wherein the at least one region is not continuous.

18. The method of claim 9, wherein the second analytics protocol generates a three dimensional representation of elements depicted within the second screen image.

19. The method of claim 9, wherein the second analytics protocol generates a proportional and positionally related representation of (a.) elements depicted within the second screen image and (b.) elements rendered both outside of the second screen image and within the first screen image.

20. A method comprising:
a. Receiving a region identification by a first computational device, wherein the region identification is related to a geographically embodied region;
b. Receiving a data set comprising both (a.) regional data set directly associated with the region identification and (b.) a distinguishable contextual data set associated with an environ of the region;
c. Rendering the contextual data set via the video display module as derived from an application of a first analytics protocol to the data set to generate a first screen image; and
d. Rendering the regional data set as derived from an application of a second analytics protocol to the regional data set to generate a second screen image, whereby the second screen image is overlaid within the first screen.

21. The method of claim 20, further comprising:
a. a remote server at least partially processing the data set by a third analytics protocol to derive a screen image data set;
b. the remote server transmitting the screen image data set to the first computational device; and
c. the first computational device applying at least an element of the screen image data in rendering the first screen image.

22. The method of claim 20, further comprising
a. the first computational device identifying the region identification to a remote server;
b. the remote server associating the region identification with the regional data set;
c. at least partially processing the regional data set by a fourth analytics protocol to derive a detailed screen image data set;
d. the remote server transmitting the detailed screen image data set to the local device; and
e. the first computational device applying an element of the detailed screen image data in rendering the second screen image.

23. The method of claim 20, further comprising a transmission of the both the derived contextual data set and the derived regional data set from the first computational device to an alternate device and wherein the rendering of the data set is performed by the alternate device.

24. The method of claim 20, wherein the derived contextual data set includes a representation of the regional data set.

25. The method of claim 20, wherein the second analytics protocol generates a three dimensional representation of elements depicted within the second screen image.

26. The method of claim 20, wherein the second analytics protocol generates a proportional and positionally related representation of (a.) elements depicted within the second screen image and (b.) elements rendered both outside of the second screen image and within the first screen image.
